(19) United States
(12) Patent Application Publication
(10) Pub. No.: US 2008/0081088 A1
(43) Pub. Date: Apr. 3, 2008

(54) Phosphoric acid beverages with calcium to phosphorus ratios of 1:1 or greater and methods of making

(76) Inventors: Steven N. Lederman, Palm Springs, CA (US); Carolyn M. Merkel, North Haledon, NJ (US)

Correspondence Address: Steven N. Lederman, 1247 S. Gene Autry Trail, Palm Springs, CA, 92264, US

(21) Appl. No.: 11/541,661

(22) Filed: Sep. 30, 2006

(51) Int. Cl. A23L 1/30

(52) U.S. Cl. 426/74; 426/590

(57) ABSTRACT

Phosphoric acid-based beverages and beverage concentrates supplemented with calcium, phosphorus and optionally magnesium salts. The consumable beverage maintains a calcium/phosphorus ratio of 1:1 or greater. These stabilized phosphoric acid-based beverages have a pH 3.5-5.0 and may be artificially sweetened in addition to sucrose, fructose and other sweeteners and methods of making.

### BACKGROUND OF THE INVENTION

Soft drinks, in particular carbonated soft drinks (CSD), are a ubiquitous part of the American diet, especially among young people. In 2005, Americans consumed over 10 billion (192 ounce) cases of CSD¹, which equals a per capita consumption of over 800 eight ounce servings.

These remarkable consumption numbers show some decrease from previous years as the consumer has switched to more bottled water and alternative beverage (e.g., sports drinks) consumption. Part of this shift in consumption has been due to a shift away from high calorie, sugar-containing products to ones with perceived health benefits. None-the-less, soft drinks continue to crowd out healthful beverages, particularly for teenagers.

For example, the consumption of milk, a good source of calcium and magnesium in the diet, has decreased dramatically over the last few decades. In 1977-1978, boys 13-18 years old consumed about twice as much milk as soft drinks, but by 1998, they consumed more than twice as much soft drinks as milk².

TABLE 1
Daily Beverage Consumption 13–18 years old, 1999–2002 US²

| User | | Boys | | Girls | | All | |
|---|---|---|---|---|---|---|---|
| type* | Products | Oz | Kcal | Oz | Kcal | Oz | Kcal |
| All | CSD + Fruit Drinks | 30 | 363 | 22 | 254 | 26 | 310 |
| | Milk | 11 | 160 | 7 | 98 | 9 | 130 |
| Users | CSD + Fruit Drinks | 35 | 416 | 26 | 302 | 31 | 361 |
| only | Milk | 19 | 277 | 14 | 205 | 17 | 245 |

*“All” includes all boys and girls, regardless of beverage consumption. “Users only” includes consumption data only for users of each specific product.

It is obvious from the consumption data that not only is the consumption of milk on average low among teenagers, but that many teens must consume no milk products at all.

The displacement of milk from the American teenager's diet has led to alarm over the possible future health consequences. According to the American Academy of Pediatrics:

“Potential health problems associated with the high intake of sweetened drinks are 1) overweight or obesity attributable to additional calories in the diet; 2) displacement of milk consumption, resulting in calcium deficiency with an attendant risk of osteoporosis and fractures; and 3) dental caries and potential enamel erosion.”³

The loss of calcium from the diet by the displacement of milk with CSD is compounded by the acidulants used in many soft drinks, particular cola and pepper beverages. Of the 10 billion cases of CSDs consumed, over 50% are in the form of carbonated beverages which contain phosphoric acid as an acidulant¹. It is well-known that dietary calcium must be balanced with dietary phosphorus sources so as to most effectively allow for lowering the risk of disease. For example, Dr. Victor LaMer of Columbia University reported to the American Association for the Advancement of Science in 1932 that “they (calcium and phosphorus) must be taken in definite proportions, a ratio of weight ranging between two parts calcium to one of phosphorus or equal parts of both.”⁴
“Having too much phosphorous in the body is actually more common and more worrisome than having too little of this mineral. Excessive phosphorous is generally caused by kidney disease or by consuming too much dietary phosphorous relative to dietary calcium. As dietary phosphorous increases, the need for additional calcium rises as well. The delicate balance between calcium and phosphorous is necessary for proper bone density and prevention of osteoporosis . . . Nutritionists recommend a balance of calcium and phosphorus in the diet. The typical Western diet, however, is imbalanced in these minerals. Most people who consume this type of diet consume roughly two to four times more phosphorus than calcium. For example, meat and poultry contain 10 to 20 times as much phosphorus as calcium, and carbonated beverages such as colas have as much as 500 mg of phosphorus in one serving. When there is more phosphorus than calcium in the system, the body will draw on calcium stored in bones. This can lead to reduced bone mass (namely, osteopenia or osteoporosis) that makes bones brittle and fragile. It can also lead to gum and teeth problems. A balance of dietary calcium and phosphorus can lower the risk of osteoporosis, and relieve the symptoms of osteoarthritis and other problems related to the body's ability to use calcium.”⁵

In fact, the US Food and Drug Administration has ruled that foods fortified with calcium are ineligible for the health claim linking calcium and osteoporosis if the food contains more phosphorous than calcium on a weight basis.⁶ The FDA ruled to limit the health claims for calcium-fortified products containing high levels of phosphorous “based on the ubiquitous distribution of this mineral in the food supply, the low ratio of calcium to phosphorous that typifies current intake patterns, and current evidence demonstrating that high levels of dietary phosphorous coupled with low dietary calcium adversely influence hormonal factors that regulate calcium and bone metabolism.”⁷

While many cola and pepper beverages may not contain very high levels of phosphorous (for example, the Coca-Cola Company states that an 8 ounce serving of Coca-Cola Classic contains 41 mg of phosphorous)⁸, it is the deficit of calcium which causes concern. Addition of traditional calcium salts (e.g., calcium chloride, calcium sulfate, etc.) to carbonated phosphoric acid-based beverages is not possible due to the minimal solubility of the resulting calcium phosphate and/or calcium carbonate salts. Thus it has not been possible to supplement many of the most popular beverage types and flavors with calcium due to technical limitations.

However, shifting consumption of children and teenagers to healthier beverage choices has proven to be very difficult. For example, the Body Mass Index (BMI) did not change for 1704 students whose school districts spent $20 million changing lunch menus, exercise programs and nutritional education.⁹ These negative results have led many researchers to conclude that children are conditioned to accept only a limited diet. Therefore changing the desired and currently accepted products to healthier versions makes more sense.

The ideal CSD beverage that will both appeal to children as well as more closely meet their nutritional needs therefore should contain:
1. Reduced amounts of sugar to moderate excess calories.
2. Reduced amount of sugar and acid to lessen incidence of dental caries.
3. Provide additional dietary calcium at a ratio of calcium to phosphorus of 1:1 or more in the dietary source.

Prior art discloses many attempts to solve different aspects of this problem. For example, U.S. Pat. No. 4,737,375 to Nakel, et. al, issued Apr. 12, 1988¹⁰ teaches that various specific combinations of primary acids of citric, phosphoric and malic acids can be used along with “suitable sources of calcium” to prepare “stable” calcium fortified soft drinks.¹⁰ The resulting beverages however do not meet the ideal beverage criteria as the invention requires use of 4-7 times the weight of acid to calcium, making the beverages too high in acid. In addition, the beverages are only stable for 60 days at room temperature, without the addition of more acid. The shelf life of current carbonated beverages is 6 months for sugar-sweetened and 3 months for aspartame-sweetened diet beverages, so obviously the invention does not meet industry-standard shelf life requirements. Nakel, et al additionally note that calcium supplementation results in an aftertaste which is dependent upon the acid ratios. Nakel further states that this aftertaste is due to precipitation of calcium in the mouth as the beverage is exposed to higher pH and increased temperatures.

U.S. Pat. No. 4,722,847 to Heckert et. al., issued Feb. 2, 1988 teaches the use of various combinations of primary acids of citric and malic acids to solubilize calcium for use in making fruit juice based beverages. In this case the acids are mixed with calcium carbonate or calcium hydroxide to form solubilized calcium prior to the addition of juice concentrates. Heckert et. al requires a total acids to calcium of about 1 to about 6. Additionally, Heckert et. al calls for stabilizers to keep the calcium in solution.¹¹ U.S. Pat. No. 7,052,725 B2 to Chang, et. al., issued May 30, 2006 note that while the citric and malic acid based soluble calcium solutions are appropriate for fruit-based flavor systems, the flavor of the acids, in particular malic acid, is incompatible with cola beverages.¹²

The invention described in Chang, et. al relates to a particular method required to make phosphoric acid-based soft drinks, in particular colas. In this method, an artificially-sweetened beverage or beverage concentrate is made by first solubilizing or dispersing specific calcium salts in water, adding edible acids, adding the artificial sweetener, and then adding additional ingredients such as flavors, caffeine, etc. to the resulting mix. Chang et. al specifically note that the colas require a lower pH (<4 and desirably <3) to deliver acceptable taste and stability to the beverage. To achieve this lowered pH in the presence of nutritionally significant levels of calcium, large amounts of acid are necessary. For example, the weight ratio of elemental calcium to elemental phosphorous is around 0.77:1 in the cola formulations provided and all formulations provide for additional acidity from citric acid. As noted above, this ratio of calcium to phosphorus is well below the nutritionally recommended ratio. Additionally, Chang et. al note that the pH of the aspartame-sweetened beverage must be reduced as aspartame potency is reduced at higher pH. All of the Chang et. al. examples are formulated to obtain an elemental calcium claim of 100 mg per 8 ounce serving. It is obvious from Chang et. al. that the issues discussed of pH, flavor, solubility etc. become even more compounded if one were to make an elemental calcium serving of 150 mg or more per 8 ounces per Chang et. al.

This added requirement for acid, and the use of an acid system containing two or more primary acids, is supported by the teachings of Nakel, et. al. Nakel, et. al. teaches that thermodynamics of calcium precipitation require that 1) high levels of acid are needed to maintain solubility, 2) systems containing two or more acids are needed to maintain solubility and 3) systems containing too much calcium (for the formulation) present unpleasant aftertastes when the calcium precipitates slowly upon meeting the higher pH in the mouth.

U.S. Pat. No. 6,569,477 to Lederman issued May 27, 2003 teaches a method of preparation of calcium and calcium-magnesium salts of edible acids to make stable soluble calcium and calcium-magnesium supplements for products including beverages. The edible calcium and calcium-magnesium salts using phosphoric acid using the method taught by Lederman U.S. Pat. No. 6,569,477 have essentially the same “buffering/flavor/low pH” issues as described herein. The addition of, for example, significant levels of phosphoric acid is described as required to produce a stable as well as organoleptically acceptable cola beverage. Typically, a ratio of two to three times the weight of acid to mineral was considered essential to effect complete solubilization of the resulting mineral salt as well as provide additional free acid so as to provide appropriate organoleptic properties.¹³ Therefore all previous teachings of methods to provide calcium in beverages, specifically primarily single acid phosphoric acid-based beverages such as colas or pepper beverages, uniformly provide for nutritionally unsound levels of phosphorus and other acids.

By the year 2002 the move to remove carbonated soft drinks from schools had gained momentum in the United States. The movement primarily focused on excess sugar and caffeine in soft drinks, and the displacement of calcium-containing drinks from the diet of children and adolescents.

Studying the components of carbonated soft drinks showed the consumer preferred drinks to have as major/primary components/requirements a cola, pepper or phosphoric acid aligned flavor, phosphoric acid (for flavor and acid), a low pH, caramel color and a sweetener either “regular” (sucrose, high fructose corn syrup, etc.) or one of the “diet” (low calorie) sweeteners. With these parameters a calcium and magnesium supplemented cola was made using the method for preparing soluble calcium and magnesium salts taught in Lederman 477. It became obvious that an unbalanced ratio of calcium to phosphorus (i.e., too much phosphorus relative to the amount of calcium) resulted when previously known techniques were used to prepare these beverages. The amount of phosphoric acid needed to reach the low pH typical for these type drinks was enormous. To use other primary acids such as malic or citric that also come with their own flavor would detract from the cola, pepper or phosphoric acid aligned flavor.

In reviewing the label claims for these samples (regardless of taste), by the time you reached the low pH (typically around 2.5) of these beverages, an 8 ounce serving containing 100 mg elemental calcium (10% of the RDI) contained enough phosphorus that the phosphorus should be claimed on the Nutrition Facts label. The 8 ounce serving containing 100 mg elemental calcium would also contain 200 mg (20% of the RDI) to as much as 700 mg (70% of the RDI) or more elemental phosphorous. This is not healthy. The data in Table 1 demonstrate that many teenagers drink 3-4 times this amount of soft drink per day which would result in the unacceptable consumption of potentially 3 or more times the RDI of phosphorus. You could reduce the phosphorous nutritional levels by replacing significant amounts of the phosphoric acid (caused by the buffering effects of the calcium) with other acids. This would reduce the phosphorous levels but as noted by Chang et. al the flavor of the other acids significantly affects the taste of the cola or pepper beverage, making most acid substitutions organoleptically unacceptable.

A study of the correct elemental calcium to elemental phosphorous ratio revealed that the added elemental phosphorus as a consequence of the addition of phosphoric acid must be balanced appropriately with the elemental calcium for optimal bioavailability. The appropriate ratio of elemental calcium to elemental phosphorus is currently known to be 1:1 or more for optimal health.

More elemental phosphorus than elemental calcium per serving could disallow any osteoporosis claims. On the other hand, having an 8 ounce serving of a beverage with elemental calcium of at least 200 mg and elemental phosphorus of 200 mg or less would allow for exceptional healthy claims.⁶

So, the elemental calcium to elemental phosphorus ratio of at least 1:1 became a major criterion.

To that end, soluble calcium and/or calcium and magnesium salts containing appropriate levels of phosphorus were prepared (see Examples below) with the elemental calcium to phosphorus ratio being 1:1 or better. In Example 1 below the solubilized elemental calcium to phosphorus ratio is 1.15:1.

Cola and pepper beverages prepared with these soluble calcium and/or calcium and magnesium salts have an unadjusted pH of about 4 due to the buffering effect of the salts. To reduce the pH to levels more typical of traditional cola and pepper beverages, large amounts of phosphoric acid or an additional acid such as citric acid are required. In this invention, we have discovered that cola and pepper beverages made with soluble calcium and/or calcium and magnesium phosphate salts can be made to not require large amounts of additional acid to provide the organoleptic properties typically provided by these beverages. In all embodiments, the calcium and/or calcium and magnesium and phosphorus supplemented beverages have taste profiles similar to or superior to comparable non-supplemented beverages.

Surprisingly, what we have discovered is that particular calcium or calcium and magnesium salts of phosphoric acid can be used to supplement a beverage, and in particular a cola or pepper beverage, with calcium or calcium and magnesium without requiring large amounts of phosphoric acid or two or more edible acids in the beverage. In the beverage of this invention, the acid component to the solubilized mineral component is significantly less than in Nakel, et. al. The solubilized calcium and/or calcium and magnesium in the beverage are stable and the cola or pepper beverages have organoleptic properties equal to or better than conventional beverages. In addition, the pH of the beverage is around 4, which is desirable for increasing the stability of aspartame, a widely used low calorie sweetener. For example, a beverage sweetened with aspartame produced at a pH of 3.3 has a shelf life of three months based on the sweetener decomposition. If the pH of the same product is raised to 4.2, the shelf life doubles to 6 months. Surprisingly, in contrast to the teachings of Chang, et. al, the potency of the aspartame is not reduced in the calcium or calcium and magnesium supplemented system described herein, so that low-calorie aspartame-containing cola and pepper beverages can be practically made with longer shelf life, good taste, and positive health benefits.

In this invention we therefore describe a method to make a beverage more acceptable to children and teenagers which 1) can be prepared with less or no sugar, 2) reduces the amount of sugar and acid to lessen incidence of dental caries and 3) provides a elemental calcium to elemental phosphorus ratio is 1:1 or more, in alignment with existing nutritional guidelines. We additionally describe a method of making a cola artificially sweetened with a dipeptide sweetener and supplemented with calcium and phosphorous or calcium and magnesium and phosphorous such that the shelf life of the product is increased.

### BRIEF SUMMARY OF THE INVENTION

The present invention describes high pH phosphoric acid-based beverages and beverage concentrates supplemented with nutritionally significant amounts of elemental calcium from soluble calcium and/or soluble calcium and magnesium salts, wherein the elemental calcium to elemental phosphorus ratio is 1:1 or greater.

### DETAILED DESCRIPTION OF THE INVENTION

The present invention relates to beverages and beverage concentrates prepared with particular edible acid salts of calcium and/or calcium and magnesium, without the addition of excessive acids, in particular phosphoric acid. As described herein, “beverage concentrate” refers to concentrated complete beverage mixtures prior to dilution to ready-to-drink beverage concentration. As described herein, “stable” and “stability” refer to beverages free of precipitation or sediment formation for the shelf life of the beverage, which as an example is typically six months at normal room temperature for soft drinks.

Lederman 477¹³ describes details related to the production of soluble edible acid mineral salts. However, the elemental calcium to phosphorus is significantly less than 1:1.

In the invention described herein, the salts are further particularly described as calcium and/or calcium and magnesium salts intended for supplementing phosphoric acid-based beverages prepared by combining potable water with solubilizable forms of calcium, optionally a solubilizable form of a magnesium salt and phosphoric acid to form a solution.

The solution formed from water, solubilized calcium and optionally solubilized magnesium and phosphoric acid may then optionally be dried for ease of handling and transportation. Drying methods used may be any method known to those skilled in the art, including but not limited to tray drying, drum drying, freeze drying, vacuum drying, spray drying etc. The calcium and/or calcium and magnesium salt is then reconstituted for use in the beverage production.

Production of good-tasting beverages is well-known to those skilled in the art. In this embodiment, calcium and/or calcium and magnesium edible acid mineral salts described above, a flavor system, sweetener, preservatives and other ingredients, known to those skilled in the arts are incorporated into a beverage concentrate so that the concentrate can be appropriately diluted with water and bottled as needed, or incorporated into ready-to-use beverage solutions which are then bottled as needed. It is obvious to those skilled in the art that carbonated water is used for carbonated soft drink beverages.

The following examples are intended as examples and in no way demonstrate limitations of this invention. It is recognized that commercially available materials are used in this invention and that ones skilled in the art may use the teachings herein to provide other examples. All references to serving sizes are for 8 fluid ounces.

### EXAMPLE 1

A good-tasting low-calorie cherry flavored pepper beverage is prepared by making a beverage concentrate then diluting the concentrate with carbonated water. The concentrate is mixed by combining 191 gallons of 60° C. potable water with 1.7 pounds of sodium benzoate, 94 pounds of Calcium Magnesium Blend (prepared as described in Lederman) and 42 fl. Oz. of 80% H₃PO₄. This addition of H₃PO₄ provides less than one mg of additional Phosphorus to this beverage. This solution is mixed for 30 minutes with good agitation, filtered, cooled and then 2 gallons of cherry cola flavor and 62 fl. Oz. sucralose liquid concentrate (SPLENDA® sweetener) is added. The concentrate is diluted with 3 parts carbonated water and bottled. The final beverage contains 219 mg of Calcium, 87 mg of Magnesium and 189 mg of Phosphorus per serving. This beverage was found to be comparable in taste, sweetness and mouthfeel to commercially available diet pepper beverages, and remains good-tasting and clear with no sediment formation after one year storage at room temperature.

### EXAMPLE 2

A good-tasting low-calorie cola beverage is prepared by making a beverage concentrate then diluting the concentrate with carbonated water. The concentrate is mixed by combining 191 gallons of 60° C. potable water with 1.7 pounds of sodium benzoate, 94 pounds of Calcium Magnesium Blend (prepared as described in Lederman) and 65 fl. Oz. of 80% H₃PO₄. This addition of H₃PO₄ provides less than one mg of additional Phosphorus to this beverage. This solution is mixed for 30 minutes with good agitation, filtered, cooled and then 2 gallons and 16 fl. Oz. of cola flavor and 82 fl. Oz. sucralose liquid concentrate (SPLENDA® sweetener) is added. The concentrate is diluted with 3 parts carbonated water and bottled. The final beverage contains 219 mg of Calcium, 87 mg of Magnesium and 189 mg of Phosphorus per serving. This beverage was found to be comparable in taste, sweetness and mouthfeel to commercially available diet cola beverages, and remains good-tasting and clear with no sediment formation after one year storage at room temperature.

### EXAMPLE 3

A good-tasting low-calorie cola beverage is prepared by making a beverage concentrate then diluting the concentrate with carbonated water. The concentrate is mixed by combining 191 gallons of 60° C. potable water with 1.7 pounds of sodium benzoate, 94 pounds of Calcium Magnesium Blend (prepared as described in Lederman) and 65 fl. Oz. of 80% H₃PO₄. This addition of H₃PO₄ provides less than one mg of additional Phosphorus to this beverage. This solution is mixed for 30 minutes with good agitation, filtered, cooled and then 2 gallons and 16 fl. Oz. of cola flavor and 3.68 pounds of aspartame is added. The concentrate is diluted with 3 parts carbonated water and bottled. The final beverage contains 219 mg of Calcium, 87 mg of Magnesium and 189 mg of Phosphorus per serving. This beverage was found to be comparable in taste, sweetness and mouthfeel to commercially available diet cola beverages, and remains good-tasting and clear with no sediment formation after one year storage at room temperature.

### EXAMPLE 4

A good-tasting full-calorie cola beverage is prepared by making a beverage concentrate then diluting the concentrate with carbonated water. The concentrate is mixed by combining 191 gallons of 60° C. potable water with 1.7 pounds of sodium benzoate, 94 pounds of Calcium Magnesium Blend (prepared as described in Lederman) and 65 fl. Oz. of 80% H₃PO₄. This addition of H₃PO₄ provides less than one mg of additional Phosphorus to this beverage. This solution is mixed for 30 minutes with good agitation, filtered, cooled and then 2 gallons and 16 fl. Oz. of cola flavor and 680 pounds of sucrose is added. The concentrate is diluted with 3 parts carbonated water and bottled. The final beverage contains 219 mg of Calcium, 87 mg of Magnesium and 189 mg of Phosphorus per serving. This beverage was found to be comparable in taste, sweetness and mouthfeel to commercially available full-calorie cola beverages, and remains good-tasting and clear with no sediment formation after one year storage at room temperature.

### EXAMPLE 5

The following formula is an example of a composition used in the present invention. These components are processed as taught by Lederman U.S. Pat. No. 6,569,477 B2. This example is illustrative of the compositions taught in this invention and is not limiting in any sense.

| Ingredients | | Elemental | | Ratio |
|---|---|---|---|---|
| Calcium Hydroxide | 32.2% | Calcium | 17.4 gram | 1.08 |
| Phosphoric Acid 75% | 67.8% | Phosphorous | 16.1 gram | 1 |
| | 100% | | | |

### REFERENCES

¹ Beverage Digest, vol. 48, no. 7
² Jacobsen, M. F. “Liquid Candy. How Soft Drinks Are Harming Americans' Health”. Center for Science in the Public Interest, Washington, D.C. 2005.
³ American Academy of Pediatrics, Policy Statement “Soft Drinks in Schools”, Pediatrics, 113:1, January 2004.
⁴ Associated Press article, “Rapid Aging Due to Lack of Calcium. Latest Theory on Diet Reported by Columbia University Scientists”, Los Angeles Times, Jun. 24, 1932.
⁵ http://www.umm.edu/altmed/ConsSuplements/Phosphoruscs.html
⁶21CFR 101.72
⁷ Federal Register/Vol. 58, No. 3/Jan. 6, 1993, pg 2668.
⁸ http://www.thecoca-colacompany.com/mail/goodanswer/soft_drink_nutrition.pdf
⁹ Belkin, L. “The School Lunch Test”, The New York Times Magazine, Aug. 20, 2006.
¹⁰ Nakel, G. M., Russell, W. E., Dake, T. W., and Heckert, D. C. “Beverages and Beverage Concentrates Nutritionally Supplemented with Calcium”, U.S. Pat. No. 4,737,375.
¹¹ Heckert, D. C. “Fruit Juice Beverages and Juice Concentrates Nutritionally Supplemented with Calcium”, U.S. Pat. No. 4,722,847.
¹² Chang, P. K., Lee, T. D., Olszewski, J., Edgar, B. G., Orr, R and Curtiss, H. “Calcium-Supplemented Beverages and Method of Making Same”. U.S. Pat. No. 7,052,725 B2.
¹³ Lederman, S. N. “Highly soluble and stable mineral supplements containing calcium and magnesium and methods of making”, U.S. Pat. No. 6,569,477.

What is claimed:

1. A flavored, sweetened beverage or beverage concentrate supplemented with soluble calcium and phosphorous edible salts
containing nutritionally significant levels of elemental calcium
an elemental calcium to elemental phosphorus ratio is 1:1 or more, more preferably a elemental calcium to elemental phosphorus ratio is 1.1:1 or more,
with a flavor system and processing aids containing elements such as caffeine, coloring ingredients, caramel, miniscule amounts of free acids and anti-foaming agents and the such,
wherein the solubilized calcium and phosphorus can remain stable and solubilized in the beverage for at least 3 months more preferably 6 months.

2. The beverage or beverage concentrate of claim 1 where the flavor is cola, pepper or other flavor that benefits from phosphoric acid.

3. The beverage or beverage concentrate of claim 1 where the beverage provides at least 10% Recommended Daily Intake (RDI) of soluble calcium per 8 ounce serving.

4. The beverage or beverage concentrate of claim 1 where the beverage provides at least 100 mg of soluble calcium per 8 ounce serving.

5. The calcium and phosphorous supplemented beverage or beverage concentrate of claim 1 wherein nutritionally significant levels of micronutrient(s) and/or macronutrient(s) supplements are added, such micronutrients including but not limited to vitamins such as C, D, or E, minerals such as Potassium, Zinc, Chromium, or Iron, and/or biologically active materials such as flavonoids, anti-oxidants, or pro-biotics, and/or such macronutrients including but not limited to protein such as whey protein, or soy protein, and/or carbohydrates such as soluble fibers or fructo-oligosaccharides.

6. The calcium and phosphorous supplemented beverage or beverage concentrate of claim 5 wherein the sweetener is a nutritive sweetener including but not limited to sucrose, high fructose corn syrup, glucose, glucose syrup, or invert sugar and/or mixtures thereof.

7. The calcium and phosphorous supplemented beverage or beverage concentrate of claim 6 wherein additional sweetness is provided by one or more sweeteners including but not limited to aspartame, acesulfame potassium, alitame, neotame, sodium saccharin, calcium saccharin, sodium cyclamate, calcium cyclamate, sucralose, neohesperidin dihydrochalcone, and/or mixtures thereof.

8. The calcium and phosphorous supplemented beverage or beverage concentrate of claim 5 wherein the sweetener is one or more non-nutritive sweetener(s) including but not limited to aspartame, acesulfame potassium, alitame, neotame, sodium saccharin, calcium saccharin, sodium cyclamate, calcium cyclamate, sucralose, neohesperidin dihydrochalcone, and mixtures thereof.

9. The calcium and phosphorous supplemented beverage or beverage concentrate of claim 1 wherein the sweetener is a nutritive sweetener including but not limited to sucrose, high fructose corn syrup, glucose, glucose syrup, or invert sugar and/or mixtures thereof.

10. The calcium and phosphorous supplemented beverage or beverage concentrate of claim 9 wherein additional sweetness is provided by one or more sweeteners including but not limited to aspartame, acesulfame potassium, alitame, neotame, sodium saccharin, calcium saccharin, sodium cyclamate, calcium cyclamate, sucralose, neohesperidin dihydrochalcone, and/or mixtures thereof.

11. The calcium and phosphorous supplemented beverage or beverage concentrate of claim 1 wherein the sweetener is one or more non-nutritive sweeteners including but not limited to aspartame, acesulfame potassium, alitame, neotame, sodium saccharin, calcium saccharin, sodium cyclamate, calcium cyclamate, sucralose, neohesperidin dihydrochalcone, and/or mixtures thereof.

12. A flavored, sweetened beverage or beverage concentrate supplemented with soluble calcium, magnesium and phosphorous edible salts
containing nutritionally significant levels of elemental calcium,
an elemental calcium to elemental phosphorus ratio is 1:1 or more, more preferably a elemental calcium to elemental phosphorus ratio is 1.1:1 or more,
with a flavor system and processing aids containing elements such as caffeine, coloring ingredients, caramel, miniscule amounts of free acids and anti-foaming agents and the such,
wherein the solubilized calcium, magnesium and phosphorus can remain stable and solubilized in the beverage for at least 3 months more preferably 6 months.

13. The beverage or beverage concentrate of claim 12 where the flavor is cola, pepper or other flavor that benefits from phosphoric acid.

14. The beverage or beverage concentrate of claim 12 where the beverage provides at least 10% RDI of calcium per 8 ounce serving.

15. The beverage or beverage concentrate of claim 12 where the beverage provides at least 100 mg of calcium and at least 40 mg of magnesium per 8 ounce serving.

16. The calcium, magnesium and phosphorous supplemented beverage or beverage concentrate of claim 12 wherein nutritionally significant levels of micronutrient(s) and/or macronutrient(s) supplements are added, such micronutrients including but not limited to vitamins such as C, D, or E, minerals such as Potassium, Zinc, Chromium, or Iron, and/or biologically active materials such as flavonoids, anti-oxidants, or pro-biotics, and/or such macronutrients including but not limited to protein such as whey protein, or soy protein, and/or carbohydrates such as soluble fibers or fructo-oligosaccharides.

17. The calcium, magnesium and phosphorous supplemented beverage or beverage concentrate of claim 16 wherein the sweetener a nutritive sweetener including but not limited to sucrose, high fructose corn syrup, glucose, glucose syrup, or invert sugar and/or mixtures thereof.

18. The calcium, magnesium and phosphorous supplemented beverage or beverage concentrate of claim 17 wherein additional sweetness is provided by one or more sweeteners including but not limited to aspartame, acesulfame potassium, alitame, neotame, sodium saccharin, calcium saccharin, sodium cyclamate, calcium cyclamate, sucralose, neohesperidin dihydrochalcone, and/or mixtures thereof.

19. The calcium, magnesium and phosphorous supplemented beverage or beverage concentrate of claim 16 wherein the sweetener is one or more non-nutritive sweeteners including but not limited to aspartame, acesulfame potassium, alitame, neotame, sodium saccharin, calcium saccharin, sodium cyclamate, calcium cyclamate, sucralose, neohesperidin dihydrochalcone, and mixtures thereof.

20. The calcium, magnesium and phosphorous supplemented beverage or beverage concentrate of claim 12 wherein the sweetener a nutritive sweetener including but not limited to sucrose, high fructose corn syrup, glucose, glucose syrup, or invert sugar and/or mixtures thereof.

21. The calcium, magnesium and phosphorous supplemented beverage or beverage concentrate of claim 20 wherein additional sweetness is provided by one or more sweeteners including but not limited to aspartame, acesulfame potassium, alitame, neotame, sodium saccharin, calcium saccharin, sodium cyclamate, calcium cyclamate, sucralose, neohesperidin dihydrochalcone, and/or mixtures thereof.

22. The calcium, magnesium and phosphorous supplemented beverage or beverage concentrate of claim 12 wherein the sweetener is one or more non-nutritive sweetener(s) including but not limited to aspartame, acesulfame potassium, alitame, neotame, sodium saccharin, calcium saccharin, sodium cyclamate, calcium cyclamate, sucralose, neohesperidin dihydrochalcone, and mixtures thereof.

23. A stable mineral-fortified phosphoric acid based beverage or beverage concentrate wherein the pH is 3.5-5.0, more preferably 4.0-5.0 and most preferably 4.0-4.5, sweetened at least in part with a dipeptide sweetener including but not limited to aspartame, neotame or alitame.

24. A phosphoric acid-containing beverage supplemented with nutritionally significant levels of calcium in which precipitation or sedimentation of calcium salts does not occur for at least three month more preferably six months at room temperature.

25. The beverage or beverage concentrate of claim 24 where the beverage provides 200 mg or less of phosphorus per serving.
